(19) United States
(12) Patent Application Publication
(10) Pub. No.: US 2009/0103756 A1
(43) Pub. Date: Apr. 23, 2009

(54) Multi-Media Device

(76) Inventor: Ming-Chun Han, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/876,762

(22) Filed: Oct. 22, 2007

(51) Int. Cl. H04R 1/02; H04N 5/225

(52) U.S. Cl. 381/334; 348/220.1; 348/E05.024

(57) ABSTRACT

A multi-media device includes a media body which is a board and includes an electronic part and a support member is a board and includes a pivot portion which is pivotably connected to the media body. A first interface uses a communication protocol and has a mechanical connection.

### BACKGROUND OF THE INVENTION

1. Field of the Invention

The present invention relates generally to a multi-media device in which multiple media elements are received.

2. The Prior Arts

A conventional multi-media device such as camera, speaker and microphone are cooperated with input or output member of video or audio device of personal computers, laptops or other electronic devices so that the user can receive or transfer video or audio signals by these electronic devices. Theses multi-media device usually is built in the computer or connected to the computers or laptops by wires such as UBS connectors. However, the portable electronic devices require even smaller and thinner multi-media device to cooperate with. The applicant noticed the needs and develops the multi-media device that meets the needs of the trends.

### SUMMARY OF THE INVENTION

A primary objective of the present invention is to provide a multi-media device which includes different types of electronic parts for convenience of use for the users.

The present invention is to provide a multi-media device which includes a media body which is a board and includes an electronic part and a support member is a board and includes a pivot portion which is pivotably connected to the media body. A first interface uses communication protocol and has a mechanical connection.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing the multi-media device in accordance with the present invention;

FIG. 2 is an exploded view of the multi-media device in accordance with the present invention;

FIG. 3 shows a second embodiment of the multi-media device in accordance with the present invention;

FIG. 4 shows a plane view of the media body of the multi-media device in accordance with the present invention;

FIG. 5 shows the other surface of the media body of the multi-media device in accordance with the present invention;

FIG. 6 shows the multi-media device in FIG. 4 connected with an electronic device;

FIG. 7 shows another embodiment of the first interface of the present invention; and

FIG. 8 shows yet another embodiment of the multi-media device of the present invention.

### DETAILED DESCRIPTION OF THE PREFERRED EMBODIMENT

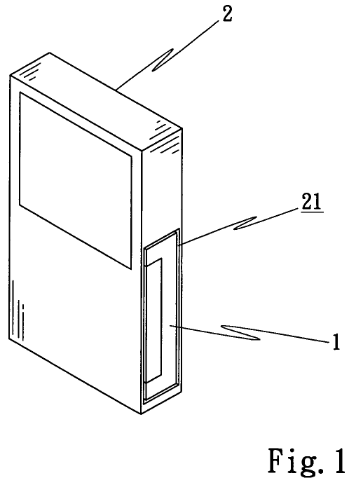

With reference to the drawings and in particular to FIGS. 1 to 3, the multi-media device 1 in accordance with the present invention is cooperated with an electronic device 2 and the multi-media device 1 is cable to take video images, generate and receive audio signals. The multi-media device 1 can also electronically connected to the electronic device 2 so as to take video, generate audio signals or receive audio signals.

The multi-media device 1 of the present invention includes a media body 11, a support member 12 and a first interface 13. The media body 11 is a board and includes an electronic part such as a video camera 11a which takes video images. The support member 12 is a board and includes a pivot portion 12a which is pivotably connected to the media body 11. The first interface 13 uses communication protocol and has mechanical connection so as to be electronically connected with the electronic device 2. The first interface 13 is electronically connected with the video camera 11a such that the video camera 11a is electronically connected with the electronic device 2 via the first interface 13 by the communication protocol.

The electronic device 2 includes a slot 21 and a second interface 22, wherein the slot 21 is shaped to accommodate the multi-media device 1 and the second interface 22 includes corresponding communication protocol of the first interface 13. The first interface 13 is electronically and mechanically connected to the second interface 22.

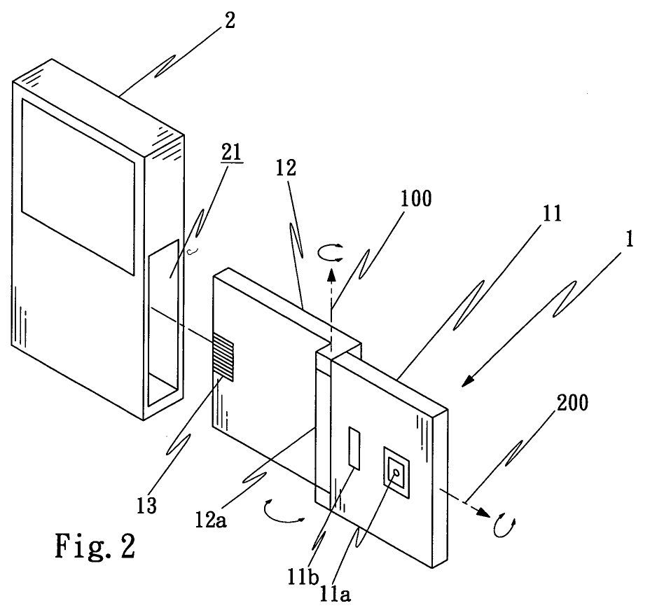

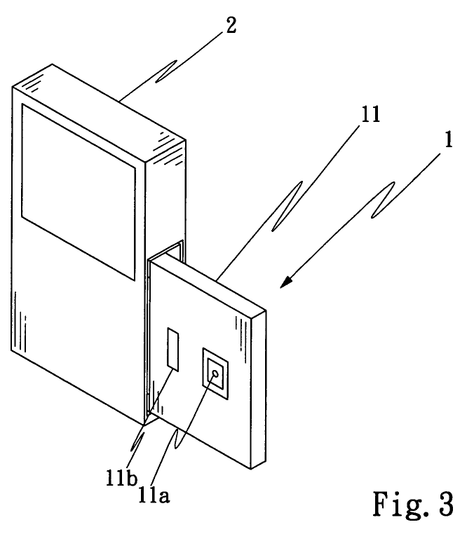

As shown in FIGS. 2 and 3, the pivot portion 12a of the support member 12 is rotated about a first axis 100 and a second axis 200 which is perpendicular to the first axis 100. The video camera 11a is connected to a surface of the media body 11 and the support member 12 and the media body 11 can be rotated about the first axis 100 or the second axis 200 by the pivot portion 12a so as to adjust the direction of the video camera 11a.

The second interface 22 of the electronic device 2 can be a PCMCIA interface of a memory card of a personal computer and the slot 21 of the electronic device 2 is sized to receive the memory card. The multi-media device 1 is cooperated with the second interface 22 of the electronic device 2, so that the size of the multi-media device 1 and the first interface 13 are compatible to the PCMCIA interface of the memory card. The multi-media device 1 is electronically connected to the second interface 22 of the electronic device 2 by the first interface 13. Besides, the first and second interfaces 13, 22 can also be defined by other standard interfaces of transmission.

The video camera 11a can use one of CMOS and CCD and the light source 11b can be a light emitting diode or any known light source.

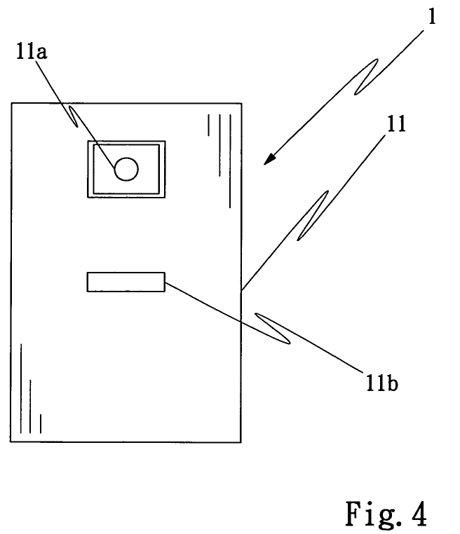

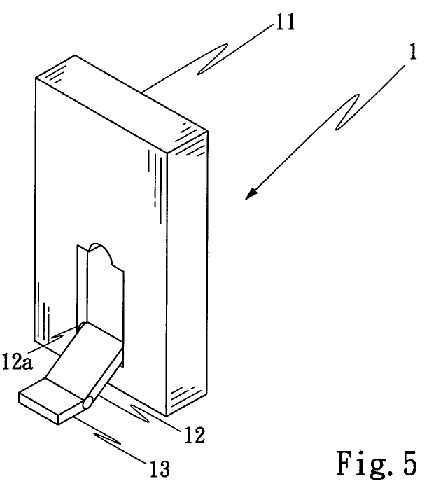

As shown in FIGS. 4 and 5, wherein the multi-media device 1 is a rectangular board and the support member 12 is another rectangular board. The video camera 11a is connected to a surface of the media body 11 and the pivot portion 12a is connected to the other surface of the media body 11. The first interface 13 is connected to the support member 12.

The media body 11 includes a light source 11b which is a light emitting member and provides complimentary light source when using the video camera 11a of the multi-media device 1.

The media body 11 of the multi-media device 1 includes a speaker 11c which is a sound generating device and outputs audio signals. The media body 11 of the multi-media device 1 can also includes a microphone 11d which is a sound input device so as to receive audio signals.

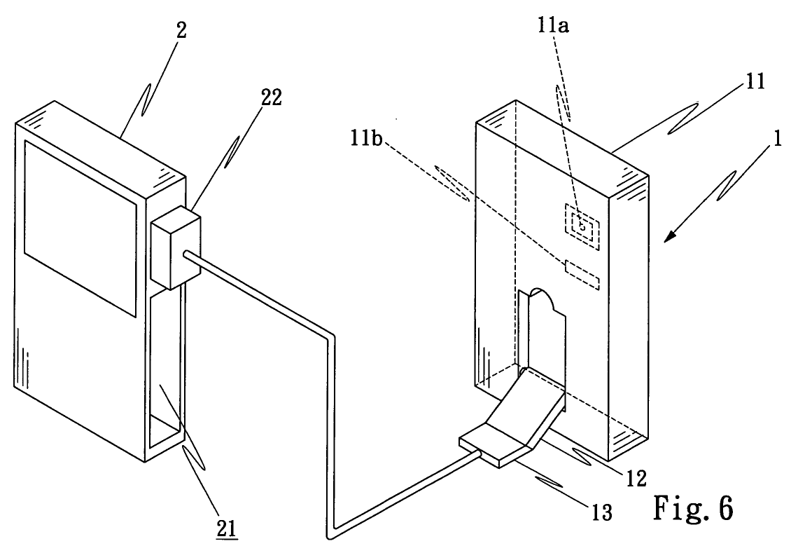

As shown in FIG. 6, the first interface 13 is located at a rear end of the support member 12 and is electronically connected to the second interface 22 of the electronic device 2 via the first interface 13 so that the multi-media device 1 is electronically connected to the electronic device 2.

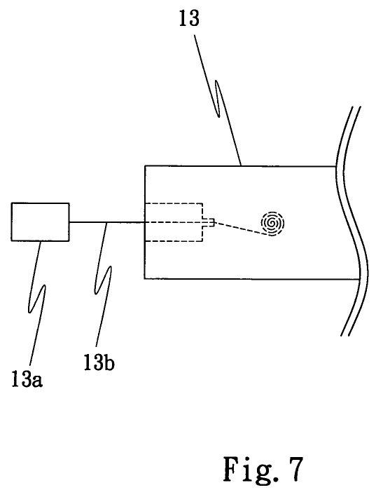

As shown in FIG. 7, the first interface 13 is located at a rear end of the support member 12 and includes a connection member 13a and an extension cord 13b. The connection member 13a is compatible to the communication protocol of the first interface 13 and the extension cord 13b is scrolled into the support member 12 so that the connection member 13a can be extended when needed.

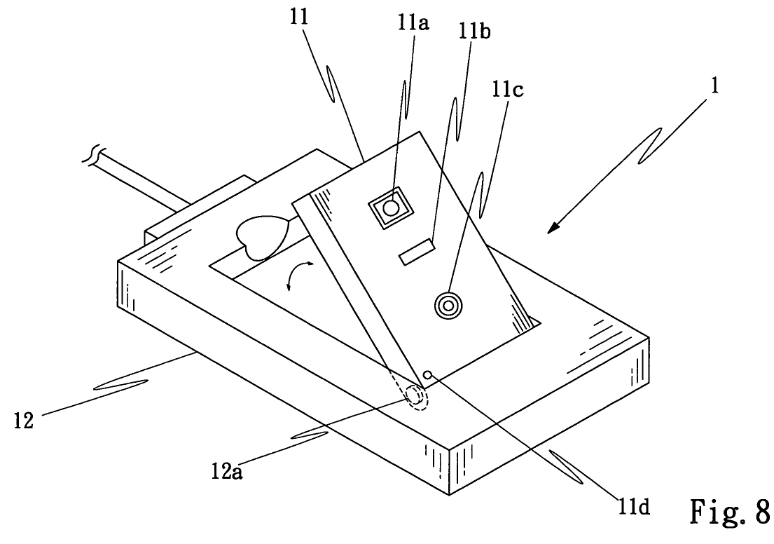

As shown in FIG. 8, the media body 11 of the multi-media device 1 is a rectangular board and the support member 12 is a hollow rectangular frame. The video camera 11a is connected to a surface of the media body 11 and the pivot portion 12a of the support member 12 is connected to a side of the media body 11. The first interface 13 is connected to the support member 12. The media body 11 and the support member 12 can be pivoted relative to each other so as to adjust the direction of the media body 11.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multi-media device, comprising
a media body being a board and including an electronic part;
a support member being a board and including a pivot portion which is pivotably connected to the media body; and
a first interface including communication protocol and mechanical connection.

2. The device as claimed in claim 1, wherein the pivot portion of the support member is rotated about a first axis and a second axis which is perpendicular to the first axis.

3. The device as claimed in claim 1, wherein the media body is a rectangular board and the support member is another rectangular board, the electronic part is connected to a surface of the media body and the pivot portion is connected to the other surface of the media body, the first interface is connected to the support member.

4. The device machine as claimed in claim 1, wherein the electronic part is a speaker.

5. The device machine as claimed in claim 1, wherein the electronic part is a microphone.

6. The device machine as claimed in claim 1, wherein the first interface is located at a rear end of the support member.

7. The device machine as claimed in claim 1, wherein the first interface is located at a rear end of the support member and includes a connection member and an extension cord, the connection member is compatible to the communication protocol of the first interface, the extension cord is scrolled into the support member.

8. The device machine as claimed in claim 1, wherein the media body is a rectangular board and the support member is a hollow rectangular frame, the electronic part is connected to a surface of the media body and the pivot portion of the support member is connected to a side of the media body, the first interface is connected to the support member.

9. The device machine as claimed in claim 1, wherein a size of the multi-media device 1 and the first interface uses PCMCIA.

10. The device machine as claimed in claim 1, wherein the electronic part is a video camera which takes video images.

11. The device machine as claimed in claim 10, wherein the video camera uses one of CMOS and CCD.

12. The device machine as claimed in claim 1, wherein the media body includes a light source which is a light emitting member.

13. The device machine as claimed in claim 12, wherein the light source is a light emitting diode.
